(19) United States
(12) Patent Application Publication
(10) Pub. No.: US 2007/0120943 A1
(43) Pub. Date: May 31, 2007

(54) Dual-sided thermal printing with labels

(75) Inventors: Michael J. Van Demark, Springboro, OH (US); Dale R. Lyons, Suwanee, GA (US); Michael E. Hetrick, Dayton, OH (US)

Correspondence Address: Douglas Foote;Intellectual Property Section, Law Department, NCR Corporation, 1700 South Patterson Blvd., Dayton, OH, 45479-0001, US

(73) Assignee: NCR Corporation

(21) Appl. No.: 11/290,723

(22) Filed: Nov. 30, 2005

(51) Int. Cl. B41J 2/315

(52) U.S. Cl. 347/221

(57) ABSTRACT

A temperature sensitive recording element for two-sided direct thermal printing comprises a substrate having temperature sensitive coatings on opposite sides of the substrate and includes a detachable thermal label element. A thermal label element with a temperature sensitive coating and backed with a contact adhesive is disclosed.

### BACKGROUND

Duplex or dual-sided direct thermal printing of transaction documents or receipts is described in U.S. Pat. Nos. 6,784,906 and 6,759,366. The printers are configured to allow printing on both sides of thermal media moving along a feed path through the printer. In such printers a direct thermal print head is disposed on each side of the media feed path. A thermal print head faces an opposing platen across the feed path from the print head.

In direct thermal printing, a print head selectively applies heat to paper or other sheet media comprising a substrate with a thermally sensitive coating. The coating changes color when heat is applied, by which “printing” is provided on the coated substrate. For dual-sided direct thermal printing, the sheet media substrate may be coated on both sides.

Duplex or dual-sided direct thermal printing has been described for providing variable information on both sides of a paper receipt, to save materials and to provide flexibility in providing information to customers. The printing can be driven electronically or by computer using a computer application program which directs dual-sided printing. A dual-sided direct thermal printer can also be configured for use in conjunction with simplex mode programs for printing of receipts or other documents.

Recording elements for one-sided direct thermal printing are known in which a detachable thermal label element is backed with a contact adhesive and adhered to a release material backing. The thermal label element has a temperature sensitive coating which changes color for direct thermal printing when heated.

### SUMMARY

A temperature sensitive recording element for two-sided direct thermal printing comprises a substrate having temperature sensitive coatings on opposite sides of the substrate and includes a detachable thermal label element. A thermal label element with a temperature sensitive coating and backed with a contact adhesive is described. The temperature sensitive recording element may, for example, be direct thermally printed on both sides of the substrate to provide a shipping document, and direct thermally printed on the thermal label element to provide a return shipping label. For another solution, the substrate may be direct thermally printed on both sides to provide a pharmacy document, and the thermal label element may be direct thermally printed to provide a pharmacy label.

### BRIEF DESCRIPTION OF DRAWINGS

FIG. 1 shows a schematic of a dual-sided imaging direct thermal printer useable for dual-sided, single pass printing of thermal media such as transaction receipts or tickets.

FIG. 2A shows a receipt with transaction detail printed on the front side.

FIG. 2B shows a receipt with supplemental information printed on the reverse side, such as variable stored information determined at the time of the transaction.

FIG. 3A shows a two-sided receipt with a portion of the associated transaction detail printed on the front side of the receipt.

FIG. 3B shows the reverse side of the receipt shown in FIG. 3A on which the remaining portion of the associated transaction data is printed.

FIG. 4 shows a temperature sensitive recording element for two-sided direct thermal printing which includes a plurality of detachable thermal label elements.

### DETAILED DESCRIPTION

By way of example, various embodiments of the invention are described in the material to follow with reference to the included drawings. Variations may be adopted.

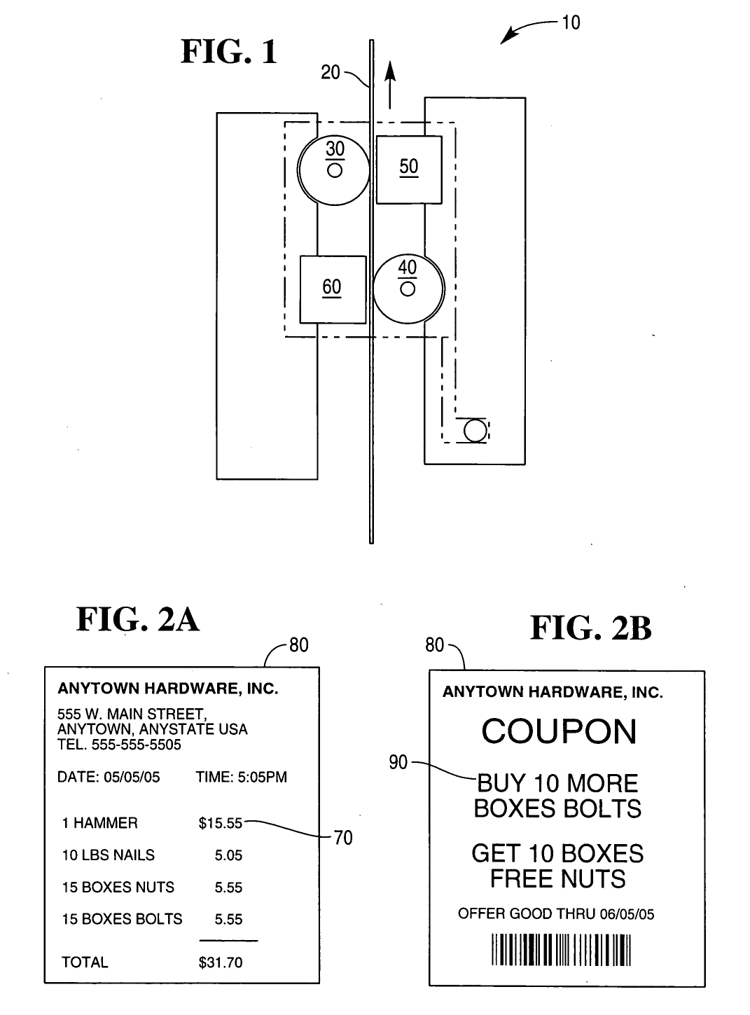

FIG. 1 shows a schematic of a dual-sided imaging direct thermal printer 10 useable for dual-sided, single pass printing of transaction receipts or tickets at time of issue. The printer 10 operates on print media 20 which is double-sided thermal paper comprising an opaque substrate, preferably a cellulosic or polymer substrate sheet coated on each side with heat sensitive dyes as described in U.S. Pat. Nos. 6,784,906 and 6,759,366. Two-color printing capability is provided for two-sided direct thermal printing on opposite sides of the receipt by using a different colored dye on each side. Substrates and heat sensitive color changing coatings for direct thermal printing media are generally well known in the art. Dual-sided direct thermal printing can be facilitated by a media 20 which includes differently colored dyes on opposite sides of the media 20, and a sufficiently thermally resistant substrate that inhibits direct thermal printing on one side of the media 20 from affecting coloration on the opposite side of the media 20.

The thermal print media 20 may be supplied in the form of a paper roll or sheet, e.g., to provide a voucher, coupon, receipt, ticket or other article or document, upon which printing such as graphics or text, or both, may be printed on both sides of the media 20.

As shown in FIG. 1, the printer 10 has rotating platens 30 and 40 and opposing thermal print heads 50 and 60 on opposite sides of the printed thermal media 20. Dual-sided direct thermal printing of the media 20 occurs in a single pass at the time of the transaction or when a receipt or ticket is issued. The media 20 can be cut or severed to provide an individual receipt or ticket document, typically once printing is completed.

FIG. 2A shows transaction detail 70 such as issuer identification, time, date, line item entries and a transaction total printed on the front side of a receipt 80. FIG. 2B shows custom information 90, e.g., based on recipient identity or transaction detail ascertained at transaction time, printed on the reverse side of the receipt 80. For example, custom information 90 could include further or duplicate transaction information, a coupon as shown, rebate or contest information, serialized cartoons, conditions of sale, document images, advertisements, security features, ticket information, or other information, e.g., custom information based on recipient identity or transaction data or detail.

Dual-sided imaging direct thermal printer 10 is configured to allow printing on both sides of a receipt or other sheet media 20 moving along a feed path 25 through the printer 10 with print heads 50 and 60 on opposite sides of the media feed path 25. Print heads 50 and 60 preferably have associated opposing platens 30 and 40 as shown.

A portion, e.g., half, of a block of data to be printed may be printed by direct thermal printing on one side of the media 20, and another portion of the data, e.g., half, may be printed by direct thermal printing on the reverse side of the media 20, or the media sides on which the respective portions of data are printed may be reversed. In this manner a transaction receipt may be generated in which a portion of the associated transaction data is printed on one side of the receipt and the remaining portion of the transaction data is printed on the other side of the receipt, conserving upon the amount of media 20 required for printing of the receipt. A dual-sided direct thermal printing function may be further be used to determine the portion or quantity of data, or a block of data, to be printed on a side of the media 20. Different blocks of data may be alternatively selected for printing.

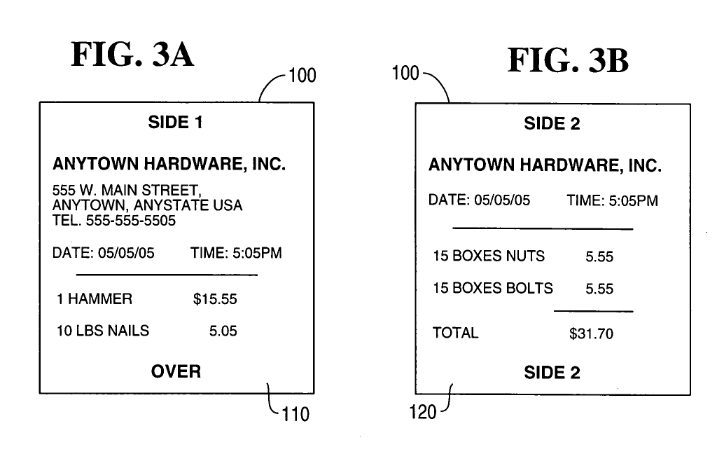

FIG. 3A shows a two-sided receipt 100 with a portion of the associated transaction detail printed on the front side 110 of the receipt 100. FIG. 3B shows the reverse side 120 of the receipt 100 shown in FIG. 3A, where the remaining portion of the associated transaction data is shown printed on the reverse side 120 of the receipt 100. Indicia such as “Front Side,” Reverse Side, ”Side 1,” “Side 2,” or the like may be included on the two sides of the receipt 100 as shown to denote the two-sided nature of the receipt 100 or the respective side of the receipt 100 being viewed. Identifying indicia such as a receipt or transaction number, terminal number, store identifier, date, time or the like may be printed on both sides of the receipt to enable association of copied images of the two sides.

A dual-sided imaging direct thermal printer 10 having pre-print data storage facilities may store one or more blocks of data to be repetitively printed on a side of the media 20, e.g., with data submitted by application software to be printed on the other media side. Where multiple data blocks are stored in the printer storage, the blocks may be alternatively selected for printing, as may be the media printing side selection.

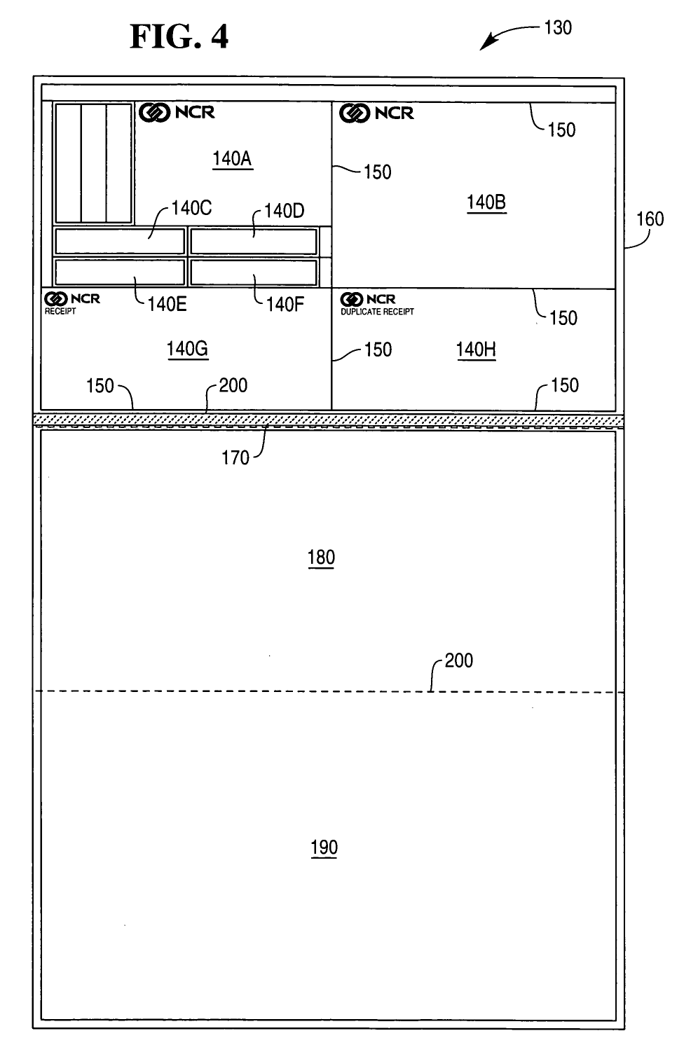

FIG. 4 illustrates an exemplary temperature sensitive recording element 130 for two-sided direct thermal printing, comprising a substrate having temperature sensitive coatings on opposite sides of the substrate. The recording element 130 includes a plurality of detachable thermal label elements 140A-140H. The thermal label elements 140A-140H each have a temperature sensitive coating and are backed with contact adhesive. The thermal label elements 140A-140H are separable along scored separation lines 150 and are adhered to a backing of release material 160. The backing 160 can be attached to the dual sided recording element 130 by a thermally activated adhesive along edge 170 of the backing 160 as shown. The recording element 130 comprises panels 180 and 190 that may be direct thermally printed on both sides and separated along perforated separation lines 200. If desired a thermal label material element 210 (not shown) may be added to the reverse side of the backing 160 so that thermal label elements 140A-140H and 210 may be direct thermally printed by opposed print heads 50 and 60 conserving upon the overall size or area of the backing 160 needed to support the different label elements. It will be noted that the backing 160 is detachable from the recording element along one of the perforated separation lines 200 as shown in FIG. 4.

A temperature sensitive recording element may, for example, be direct thermally printed on both sides of the associated coated substrate to provide a shipping document, and direct thermally printed on the thermal label element to provide a return shipping label. For another solution, the dual-sided recording element 130 may be direct thermally printed on both sides of the coated substrate to provide a pharmacy document, and the thermal label element may be direct thermally printed to provide a pharmacy label.

The description above presents a number of specific embodiments or examples of a broader invention. The invention is also carried out in a wide variety of other alternative ways which have not been described here. Many other embodiments or variations of the invention may also be carried out within the scope of the following claims.

What is claimed is:

1. A temperature sensitive recording element for two-sided direct thermal printing, comprising a substrate having temperature sensitive coatings on opposite sides of said substrate, said recording element including a detachable thermal label element.

2. The temperature sensitive recording element of claim 1 in which said thermal label element has a temperature sensitive coating and is backed with contact adhesive.

3. The temperature sensitive recording element of claim 2 in which said substrate is direct thermally printed on both sides to provide a shipping document and direct thermally printed on said thermal label element to provide a return shipping label.

4. The temperature sensitive recording element of claim 1 in which said thermal label element is adhered to a backing of release material.

5. The temperature sensitive recording element of claim 4 in which said backing of release material is attached to said recording element substrate by a thermally activated adhesive.

6. The temperature sensitive recording element of claim 4 in which said thermal label element is adhered to one side of said backing of release material and a second thermal label element is adhered to the opposite side of said backing of release material.

7. The temperature sensitive recording element of claim 4 in which said backing of release material is detachable from said recording element.

8. The temperature sensitive recording element of claim 4 in which said backing of release material is detachable by means of a perforated separation line.

9. The temperature sensitive recording element of claim 4 in which said substrate is direct thermally printed on both sides to provide a pharmacy document and direct thermally printed on said thermal label element to provide a pharmacy label.

10. A dual-sided temperature sensitive recording element for direct thermal printing on both sides of the element comprising a backing of release material and detachable thermal label elements adhered on both sides of the backing.
